(19) United States
(12) Patent Application Publication
(10) Pub. No.: US 2012/0281022 A1
(43) Pub. Date: Nov. 8, 2012

(54) ELECTRONIC APPARATUS AND IMAGE DISPLAY METHOD

(75) Inventor: Kohei MOMOSAKI, Mitaka-shi (JP)

(73) Assignee: KABUSHIKI KAISHA TOSHIBA, Tokyo (JP)

(21) Appl. No.: 13/548,517

(22) Filed: Jul. 13, 2012

Related U.S. Application Data
(63) Continuation of application No. 12/898,514, filed on Oct. 5, 2010.

(30) Foreign Application Priority Data
Oct. 5, 2009 (JP) 2009-231129

(51) Int. Cl. G09G 5/373; G09G 5/38

(52) U.S. Cl. 345/660

(57) ABSTRACT

According to one embodiment, an electronic apparatus detects face images in a still image. The apparatus sets positions and sizes of display ranges on the still image such that the display ranges include the face images respectively, the display ranges being associated with display areas obtained by dividing a display screen. The apparatus displays partial images included in the display ranges on the display areas in order to display the face images on the display areas respectively, and changes the position and size of each of the display ranges such that a display mode of the display screen is caused to transit from a first display mode in which the face images are displayed on the display areas respectively to a second display mode in which an entire image of the still image is displayed on the display screen.

### CROSS-REFERENCE TO RELATED APPLICATIONS

This application is a continuation of U.S. patent application Ser. No. 12/898,514, filed on Oct. 5, 2010, which is based upon and claims the benefit of priority from Japanese Patent Application No. 2009-231129, filed Oct. 5, 2009; the entire contents of these applications are incorporated herein by reference.

### FIELD

Embodiments described herein relate generally to an electronic apparatus and an image display method for displaying contents as still images.

### BACKGROUND

In recent years, imaging devices, such as charge-coupled devices (CCDs) or complementary metal-oxide semiconductor (CMOS) image sensors, have been configured to achieve higher resolution. Accordingly, still images, such as digital photographs, handled by an electronic apparatus, such as a mobile phone or a personal computer, have also been formed so as to achieve higher resolution.

Recently, an image reproducing apparatus known as a digital photoframe has been popularized. The digital photoframe has the function of displaying a plurality of still images stored in, for example, a card storage medium one after another at specific intervals of time. Like the digital photoframe, a personal computer, an electronic camera, or the like generally has the function of displaying a plurality of still images one after another at specific intervals of time.

Jpn. Pat. Appln. KOKAI Publication No. 2005-354333 has disclosed an image reproducing apparatus which displays a plurality of images one after another in a slideshow manner. The image reproducing apparatus has the function of zooming in the target part, such as the face part of a person, when displaying a plurality of images sequentially in a slideshow manner.

However, when a plurality of persons appear in a photograph, if the face of a person is simply zoomed in, for example, the face of an adjacent person might be covered with the zoomed-in face. In some photographs, a plurality of persons have concentrated in a part of the image. Accordingly, with the simple zooming-in approach, it is difficult to show the user in a straightforward manner what kind of person appears in the photograph.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary perspective view showing an external appearance of an electronic apparatus according to an embodiment;

FIG. 2 is an exemplary block diagram showing a system configuration of the electronic apparatus of the embodiment;

FIG. 3 is an exemplary block diagram showing a functional configuration of a content reproduction application program executed by the electronic apparatus of the embodiment;

FIG. 4 shows an example of index information used by the content reproduction application program executed by the electronic apparatus of the embodiment;

FIG. 5 shows an example of a still image handled by the electronic apparatus of the embodiment;

FIG. 6 shows an example of a first effect process carried out by the electronic apparatus of the embodiment;

FIG. 7 is an exemplary diagram to explain the areas of a still image displayed on three display areas, respectively, at the beginning of the first effect process of FIG. 6;

FIG. 8 is an exemplary diagram to explain the areas of the still image displayed on the three display areas, respectively, in the first effect process of FIG. 6;

FIG. 9 is an exemplary diagram to explain the areas of the still image displayed on the three display areas, respectively, at the end of the first effect process of FIG. 6;

FIG. 10 shows an example of a change in the enlargement factor corresponding to each of the three display areas used in the first effect process of FIG. 6;

FIG. 11 shows an example of a change in the horizontal coordinate corresponding to each of the three display areas used in the first effect process of FIG. 6;

FIG. 12 shows an example of a change in the vertical coordinate corresponding to each of the three display areas used in the first effect process of FIG. 6;

FIG. 13 shows another example of a still image to be subjected to the first effect process;

FIG. 14 shows an example of the first effect process corresponding to the still image of FIG. 13;

FIG. 15 is an exemplary flowchart to explain an example of the procedure for the first effect process carried out by the electronic apparatus of the embodiment;

FIG. 16 is an exemplary diagram to explain a second effect process carried out by the electronic apparatus of the embodiment;

FIG. 17 is an exemplary diagram to explain a third effect process carried out by the electronic apparatus of the embodiment;

FIG. 18 is an exemplary flowchart to explain the procedure for the process of changing effects according to the number of face images carried out by the electronic apparatus of the embodiment;

FIG. 19 is an exemplary diagram to explain an example of the effect process with one face image carried out by the electronic apparatus of the embodiment; and

FIG. 20 is an exemplary diagram to explain an example of the effect process with no face image carried out by the electronic apparatus of the embodiment.

### DETAILED DESCRIPTION

Various embodiments will be described hereinafter with reference to the accompanying drawings.

In general, according to one embodiment, an electronic apparatus comprises a face image detection module, a display range setting module, and a display control module. The face image detection module is configured to detect face images in a still image. The display range setting module is configured to set positions and sizes of display ranges on the still image such that the display ranges comprise the face images respectively, the display ranges being associated with display areas obtained by dividing a display screen. A display control module is configured to display partial images comprised in the display ranges on the display areas in order to display the face images on the display areas respectively, and to change the position and size of each of the display ranges such that a display mode of the display screen is caused to transit from a first display mode in which the face images are displayed on the display areas respectively to a second display mode in which an entire image of the still image is displayed on the display screen.

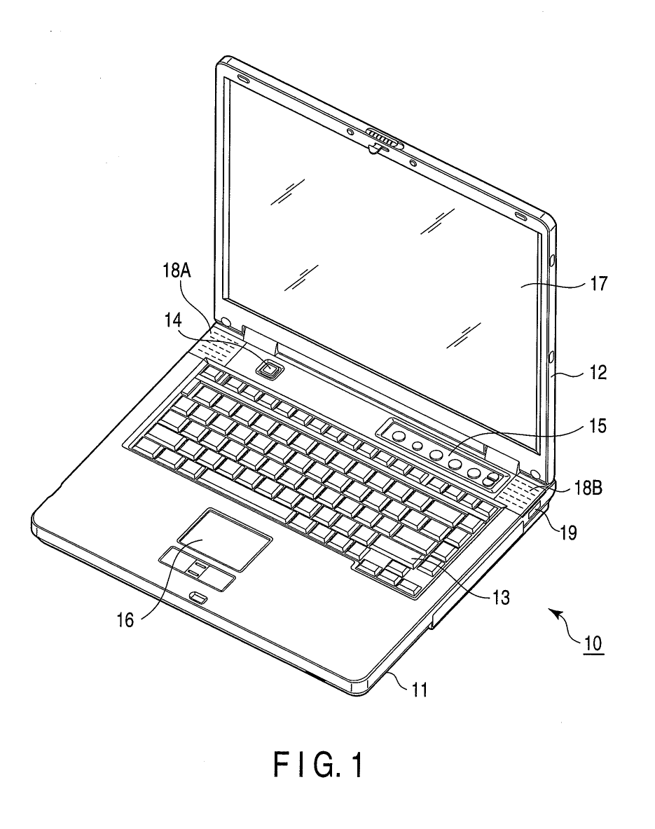

FIG. 1 is a perspective view showing an external appearance of an electronic apparatus according to an embodiment. The electronic apparatus is realized by, for example, a notebook personal computer 10. As shown in FIG. 1, the computer 10 comprises a computer body 11 and a display unit 12. The display unit 12 comprises a liquid-crystal display (LCD) 17. The display unit 12 is attached to the computer body 11 in such a manner that the unit 12 can move pivotally between the opened position where the top surface of the computer body 11 is exposed and the closed position where the top surface of the body 11 is covered with the unit 12.

The computer body 11 has a thin boxlike chassis. At the top surface of the computer body 11, there are provided a keyboard 13, a power button 14 for turning on and off the power supply of the computer 10, an input operation panel 15, a touchpad 16, speakers 18A, and 18B, and others. On the input operation panel 15, various operation buttons are provided.

At the right lateral of the computer body 11, there is provided a Universal Serial Bus (USB) connector 19 for connecting with, for example, a USB cable or a USB device complying with the Universal Serial Bus 2.0 standard. On the back of the computer body 11, there is provided an external display connecting terminal (not shown) conforming to, for example, the High-Definition Multimedia Interface (HDMI) standard. The external display connecting terminal is used to output a digital video signal to an external display.

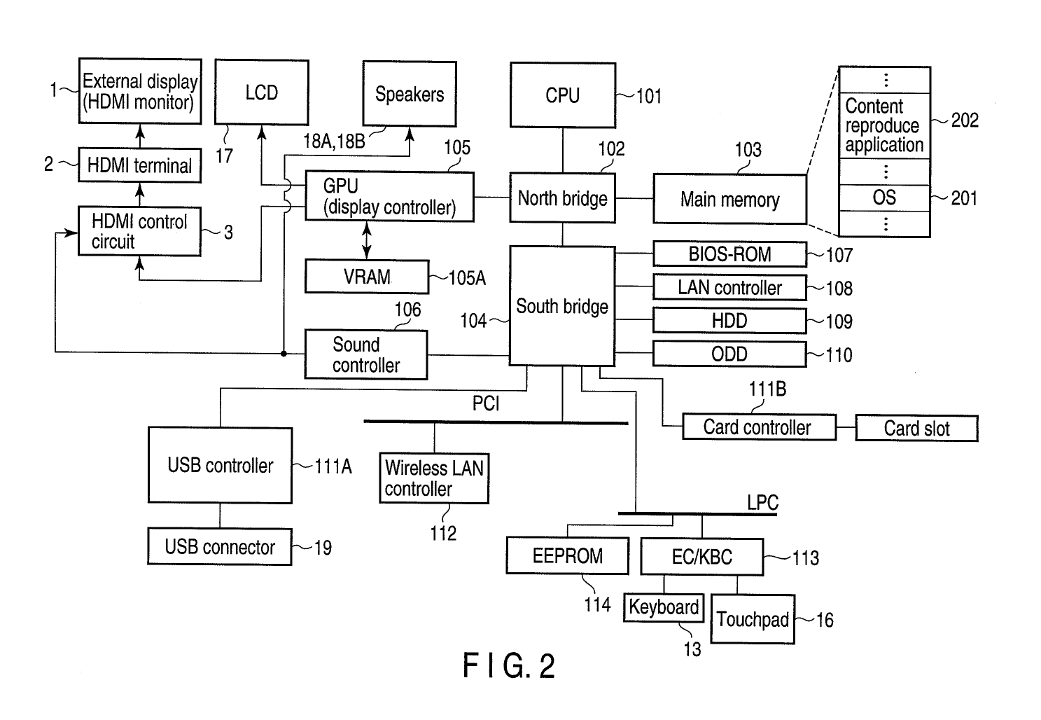

FIG. 2 shows a system configuration of the computer 10.

As shown in FIG. 2, the computer 10 comprises a central processing unit (CPU) 101, a north bridge 102, a main memory 103, a south bridge 104, a graphics processing unit (GPU) 105, a video random access memory (VRAM) 105A, a sound controller 106, a Basic Input/Output System read-only memory (BIOS-ROM) 107, a local area network (LAN) controller 108, a hard disk drive (HDD) 109, an optical disc drive (ODD) 110, a USB controller 111A, a card controller 111B, a wireless LAN controller 112, an embedded controller/keyboard controller (EC/KBC) 113, and an electrically erasable programmable ROM (EEPROM) 114.

The CPU 101, which is a processor that controls the operation of the computer 10, executes an operating system (OS) 201 and various application programs, comprising a content reproduction application program 202, which are loaded from the HDD 109 into the main memory 103. The content reproduction application program 202 is a software application program that reproduces various digital content items stored on, for example, the HDD 109. The content reproduction application program 202 has a short movie function. The short movie function comprises the function of creating and displaying a slideshow (photo movie) by using digital content, such as photographs or home videos stored on an HDD 109 or the like. The short movie function further comprises the function of causing a still image, such as a photograph, to have the effect of focusing on the face of a person.

The CPU 101 also executes the BIOS stored in the BIOS-ROM 107. The BIOS is a program for controlling the hardware.

The north bridge 102 is a bridge device which connects the local bus of the CPU 101 and the south bridge 104. The north bridge 102 comprises a memory controller which performs access control of the main memory 103. The north bridge 102 also has the function of communicating with the GPU 105 via a serial bus complying with the PCI EXPRESS standard.

The GPU 105 is a display controller which controls the LCD 17 used as a display monitor for the computer 10. A display signal generated by the GPU 105 is sent to the LCD 17. The GPU 105 can transmit a digital video single to the external display unit 1 via the HDMI control circuit 3 and HDMI terminal 2.

The HDMI terminal 2 is the external display connecting terminal. The HDMI terminal 2 can transmit an uncompressed digital video signal and a digital audio signal via a single cable to the external display unit 1, such as a TV set. The HDMI control circuit 3 is an interface for transmitting a digital video signal via the HDMI terminal 2 to the external display unit 1 called an HDMI monitor.

The south bridge 104 controls each device on a Peripheral Component Interconnect (PCI) bus and each device on a Low Pin Count (LPC) bus. The south bridge 104 comprises an integrated drive electronics (IDE) controller for controlling the HDD 109 and ODD 110. The south bridge 104 further has the function of communicating with the sound controller 106.

The sound controller 106, which is a sound source device, outputs audio data to be reproduced to the speakers 18A, 18B or HDMI control circuit 3. The LAN controller 108 is a wired communication device which performs wired communication conforming to, for example, the IEEE 802.3 standard, whereas the wireless LAN controller 112 is a wireless communication device which performs wireless communication conforming to, for example, the IEEE 802.11g standard. The USB controller 111A communicates with an external unit complying with, for example, the USB 2.0 standard. The external unit is connected via the USB connector 19. The USB controller 111A is used to receive, for example, an image data file stored in a digital camera. The card controller 111B writes and reads data into and from a memory card, such as an SD card, inserted in a card slot made in the computer body 11.

The EC/KBC 113 is a one-chip microcomputer into which an embedded controller for power management and a keyboard controller for controlling the keyboard 13 and touchpad 16 have been integrated. The EC/KBC 113 has the function of turning on and off the power supply of the computer 10 according to the result of the user operating the power button 14.

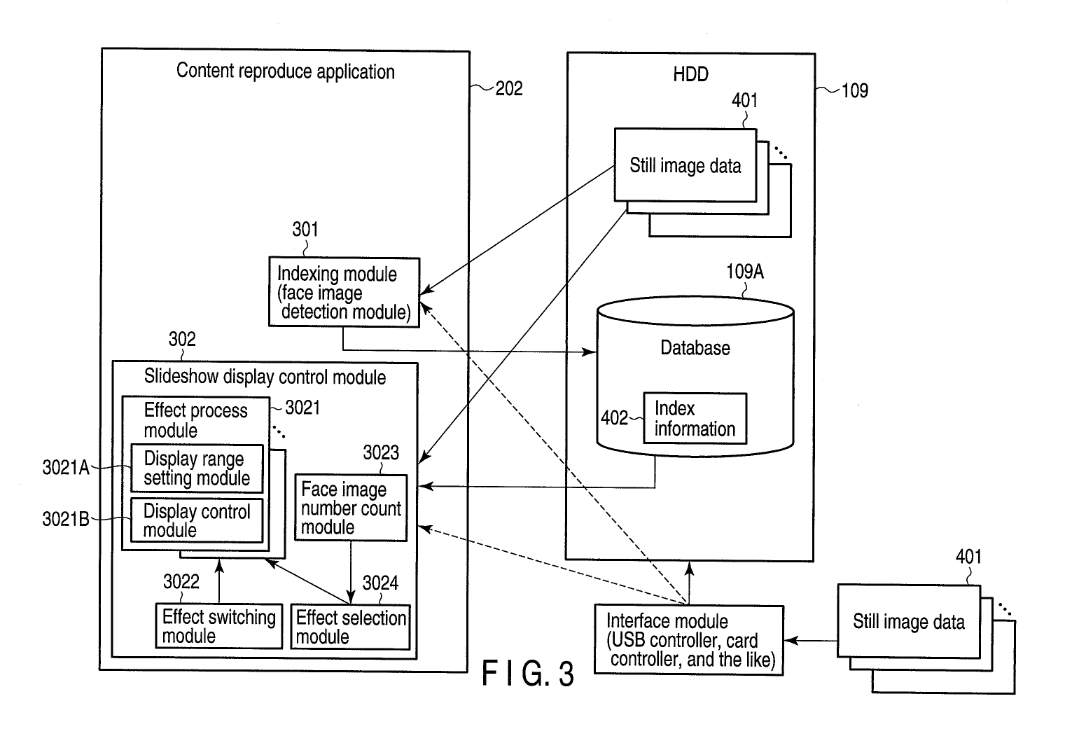

Next, a functional configuration of the content reproduction application program 202 running on the computer 10 configured as described above will be explained with reference to FIG. 3. Of the functions of the content reproduction application program 202, a configuration for realizing a short-movie function will be explained. The short movie function can be applied not only to still image data 401 stored on the HDD 109 but also to still image data 401 read from an external device (digital camera or memory card) via an interface module (the USB controller 111A and card controller 111).

As shown in FIG. 3, the content reproduction application program 202 comprises an indexing module 301 and a slideshow display control module 302.

The indexing module 301 carries out an indexing process of creating index information used to search the still image data 401 stored on the HDD 109 for a target digital image. In the indexing process, a face detection process for detecting a face image from, for example, the still image data 401 is carried out. In a still image comprising a plurality of face images, each of the plurality of face images is detected. A face image can be detected by analyzing the features of, for example, the still imaged data and searching for an area that has features similar to those of a face image feature sample previously prepared. The face image feature samples are feature data obtained by statistically processing face image features of each of a lot of persons. The position (coordinates) and size of each face image comprised in the still image are detected in the face detection process. As described above, the indexing module 301 functions as a face image detecting module which detects the positions and sizes of a plurality of face images comprised in the still image.

The still image data 401 shown in FIG. 3 may be either photograph data or frame data extracted from moving image data.

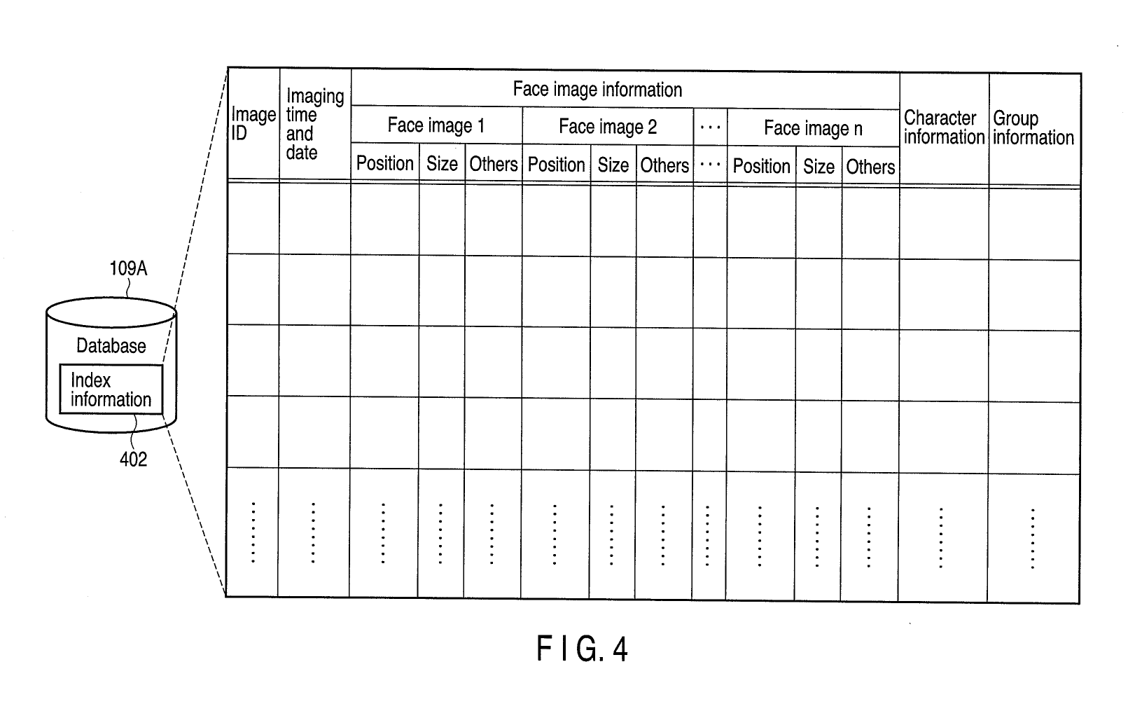

The result of the indexing process at the indexing module 301 is stored as index information 402 in the database 109A. The database 109A is a storage area prepared in the HDD 109 for storing the index information 402. FIG. 4 shows an example of the configuration of the index information 402 stored in the database 109A.

“Image ID” is identification data uniquely allocated to each of the still images 401. “Imaging time and date” is time information indicating the imaging time and date of each of the still images 401. “Face image information” comprises information on each of all the face images comprised in the still image data 401. Face image information corresponding to one face image comprises the position and size of the face image. “Character information” shows character strings comprised in the still image data 401.

Furthermore, the indexing module 301 divides a plurality of items of still image data 401 stored on the HDD 109 into groups and outputs information for identifying the individual groups. The information is stored as “group information” in the database 109A.

Use of the index information 402 makes it possible to determine whether any face image is comprised in the still image, how many face images are comprised in the still image, what character string is comprised in the still image, which group the still image belongs to, and the like. In other words, use of the index information 402 enables still image data 401 with a target person in an image, still image data 401 with a target person and a specific character in an image, or the like to be found quickly from the plurality of items of still image data 401 stored on the HDD 109.

Then, using the index information 402, the slideshow display control module 302 can select one or more items of still image data that satisfy a specific selection condition from the plurality of items of still image data 401 stored on the HDD 109. The slideshow display control module 302 can create and display a short movie that has the effect of focusing on the face of a person by using the selected one or more items of still image data.

The slideshow display control module 302 comprises an effect process module 3021, an effect switching module 3022, a face image number count module 3023, and an effect selection module 3024. The effect process module 3021 subjects a still image to an effect mode selected from a plurality of effect modes, thereby displaying the still image as a short movie where the still image moves as if it were a moving image. In the embodiment, for example, there are prepared a first effect mode (effect mode A) suitable for a still image comprising a plurality of face images, a second effect mode (effect mode B) suitable for a still image comprising one face image, and a third effect mode (effect mode C) suitable for a still image comprising no face image. In addition, each of effect modes A, B, and C comprises two or more different effects.

The effect switching module 3022 automatically switches between effects to which a still image is to be subjected. For example, when a still image comprising a plurality of face images is displayed as a short movie, the effect switching module 3022 controls the effect process module 3021, thereby automatically switching the effect to which a still image is to be subjected between the effects in effect mode A. The face image number count module 3023 counts the number of face images comprised in the selected still image. The number of face images can be counted on the basis of, for example, the index information 402. The effect selection module 3024 selects one of effect modes A, B, and C according to the number of face images comprised in the selected still image. The effect process module 3021 is informed of the selected effect mode.

Next, a “trisection zoom-out” mode, one effect in effect mode A, will be explained. The “trisection zoom-out” mode is a mode in which a short movie is displayed by using a plurality of display areas (e.g., three display areas) obtained by dividing the display screen. The display areas (e.g., three display areas) are associated with display ranges (e.g., three display ranges) on the still image, respectively. In the embodiment, for each of the display areas, the position and size of a display range on the still image corresponding to the display area is set.

More specifically, the effect process module 3021 compatible with the “trisection zoom-out” mode comprises a display range setting module 3021A and a display control module 3021B. The display range setting module 3021A sets the position and size of each of a plurality of display ranges on a still image on the basis of the position and size of each of a plurality of face images in the still image detected by the indexing module 301 so that a plurality of display ranges on the still image corresponding to a plurality of display areas in a one-to-one correspondence comprise a plurality of face images, respectively. To display a plurality of face images on a plurality of display areas in a one-to-one correspondence, the display control module 3021B displays a plurality of partial images comprised in a plurality of display ranges on a plurality of display areas, respectively. In this case, a face image whose size is smaller than a threshold value may be zoomed in so that the size of each of the face images may be normalized. Then, the display control module 3021B changes the positions and sizes of a plurality of display ranges consecutively so that the display mode of the display screen may transit from a first display mode in which a plurality of face images are displayed in a plurality of display areas, respectively, to a second display mode in which an entire image of the still image is displayed on the display screen composed of a plurality of display areas.

By doing this, a plurality of face images are displayed at first in such a manner that they are dispersed in a plurality of display areas. Then, for example, as time passes, a partial image displayed in each display area changes gradually and, finally, the entire still image is displayed on the display screen composed of a plurality of display areas.

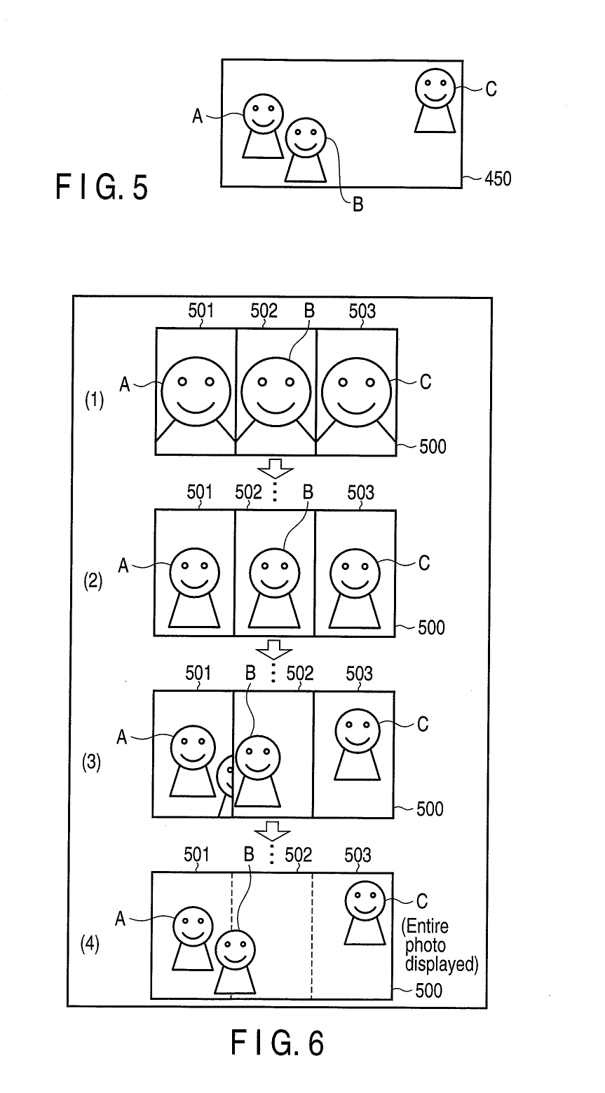

Hereinafter, an example of the “trisection zoom-out” mode will be explained with reference to FIG. 5 and FIG. 6.

FIG. 5 shows an example of the selected still image. The still image is a digital photograph that comprises face images A, B, C of three persons. FIG. 6 shows the transition of images on the display screen when the still image of FIG. 5 is reproduced in the “trisection zoom-out” mode.

In the “trisection zoom-out” mode, for example, the display screen 500 for displaying a still image reproduced as a short movie is divided longitudinally into three display areas 501, 502, 503. A first display area 501 is on the left side of the display screen 500, a second display area 502 is in the middle of the display screen 500, and a third display area 503 is on the right side of the display screen 500. Each of the three display areas 501, 502, 503 is vertically long. The three display areas 501, 502, 503 have the same size.

Illustration (1) of FIG. 6 shows images displayed on the display areas 501, 502, 503 in the first display mode. In the first display mode, three face images A, B, C are displayed on the display areas 501, 502, 503, respectively. In this case, the size of each of the three face images A, B, C is normalized by enlargement or reduction to a size fitting the size of the display area. Since the size of each of the three face images A, B, C comprised in the still image of FIG. 5 is smaller than the threshold value corresponding to the size of the display area, the three face images A, B, C are enlarged and displayed in the display areas 501, 502, 503, respectively.

Illustration (4) of FIG. 6 shows images displayed on a display screen composed of the display areas 501, 502, 503 in the second display mode. In the second display mode, the entire still image is displayed on the display screen. That is, of the three partial images obtained by dividing the still image longitudinally into three parts, the left partial image is displayed on the display area 501. On the display area 502, the central one of the three partial images is displayed. On the display area 503, the right one of the three partial images is displayed.

In the transition from the first display mode to the second display mode, the contents of the displayed image in each of the display areas 501, 502, 503 are changed continuously. Illustrations (2) and (3) of FIG. 6 show two images as the representatives of many images displayed during the transition.

In the transition from the first display mode to the second display mode, the size and position of each of the three display ranges corresponding to the display areas 501, 502, 503, respectively, are changed continuously, with the result that the contents of the displayed images in the display areas 501, 502, 503 are also changed continuously.

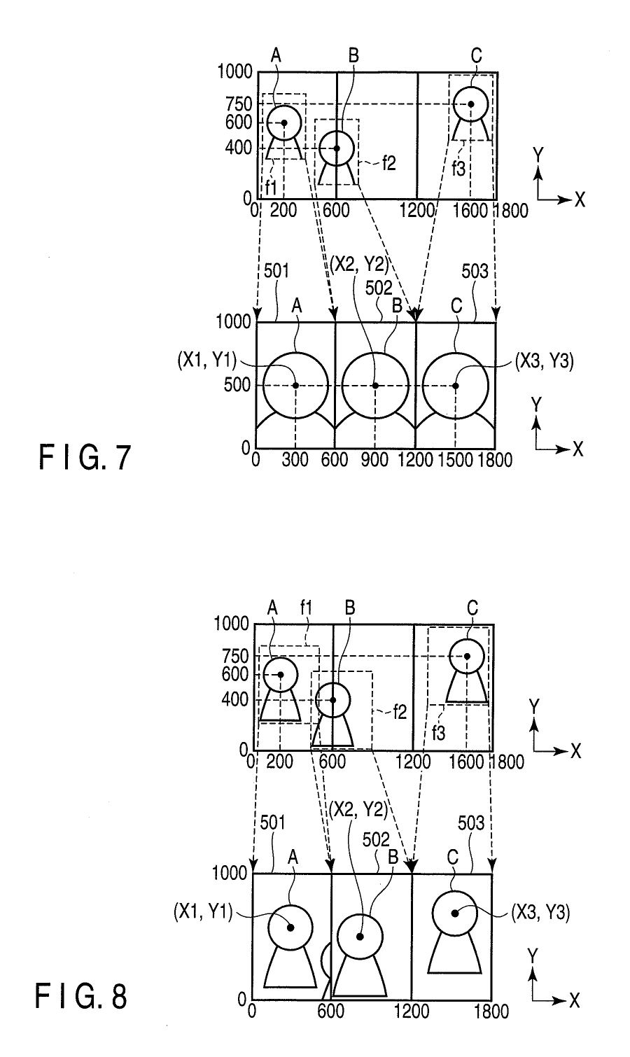

Next, how the size and position of each of the three display ranges corresponding to the display areas 501, 502, 503, respectively, are changed will be explained with reference to FIGS. 7, 8, and 9.

FIG. 7 shows the size and position of each of three display ranges f1, f2, f3 corresponding to the first display mode (the display mode shown in illustration (1) of FIG. 6). The upper part of FIG. 7 shows still image data to be displayed and the lower part of FIG. 7 shows a display screen. Suppose that the size of the still image and the size of the display screen are the same. Actually, the size of the still image often fails to coincide with the size of the final display screen. However, they are caused to correspond to one another in parallel with the above process and therefore the procedure will not be covered in the explanation.

Display range f1 shows the range of a partial image on a still image to be displayed in display area 501. Similarly, display range f2 shows the range of a partial image on a still image to be displayed in display area 502. Display range f3 shows the range of a partial image on a still image to be displayed in display area 503.

Suppose that the coordinates of the center position of face image A are (200, 600), the coordinates of the center position of face image B are (600, 400), and the coordinates of the center position of face image C are (1600, 750) as shown in FIG. 7.

Display range f1 is set to such a position and a size as comprise at least face image A on the basis of, for example, the size and position of face image A. For example, the size and position of display range f1 may be set to such a size and a position as barely comprise face image A. The effect process module 3021 displays a partial image comprised in display range f1 on display area 501 so that, for example, the center position of the partial image may be in the coordinates (300, 500) of the center position of display area 501. In this case, the effect process module 3021 may enlarge the partial image in display range f1 so that, for example, the size of the partial image in display range f1 may fit the size of display area 501. Then, the effect process module 3021 may display the enlarged partial image (i.e., an image comprising the enlarged face image A) on display area 501.

Display range f2 is set to such a position and a size as comprise at least face image B on the basis of, for example, the size and position of face image B. For example, the size and position of display range f2 may be set to such a size and a position as barely comprise face image B. The effect process module 3021 displays a partial image comprised in display range f2 on display area 502 so that, for example, the center position of the partial image may be in the coordinates (900, 500) of the center position of display area 502. In this case, the effect process module 3021 may enlarge the partial image in display range f2 so that, for example, the size of the partial image in display range f2 may fit the size of display area 502. Then, the effect process module 3021 may display the enlarged partial image (i.e., an image comprising the enlarged face image B) on display area 502.

Display range f3 is set to such a position and a size as comprise at least face image C on the basis of, for example, the size and position of face image C. For example, the size and position of display range f3 may be set to such a size and a position as barely comprise face image C. The effect process module 3021 displays a partial image comprised in display range f3 on display area 503 so that, for example, the center position of the partial image may be in the coordinates (1500, 500) of the center position of display area 503. In this case, the effect process module 3021 may enlarge the partial image in display range f3 so that, for example, the size of the partial image in display range f3 may fit the size of display area 503. Then, the effect process module 3021 may display the enlarged partial image (i.e., an image comprising the enlarged face image C) on display area 503.

FIG. 8 shows the size and position of each of three display ranges f1, f2, f3 corresponding to the display mode shown in illustration (3) of FIG. 6.

In the transition from the first display mode to the second display mode, the position of display range f1 is changed continuously from the move start position (200, 600) toward the move end position (300, 500). The move end position (300, 500) is the center position of display area 501, i.e., the center position of left partial image of the still image. The size of display range f1 is changed continuously from the initial size explained in FIG. 7 to a size coinciding with the size of display area 501. The effect process module 3021 displays a partial image in display range f1 on display area 501. Accordingly, as the position and size of display range f1 change gradually, the coordinates (X1, Y1) of the center position of face image A on display area 501 are moved gradually toward the coordinates (200, 600) which is the original position of face image A.

The position of display range f2 is changed continuously from the move start position (600, 400) toward the move end position (900, 500). The move end position (900, 500) is the center position of display area 502, i.e., the center position of central partial image of the still image. The size of display range f2 is changed continuously from the initial size explained in FIG. 7 to a size coinciding with the size of display area 502. The effect process module 3021 displays a partial image in display range f2 on display area 502. Accordingly, as the position and size of display range f2 change gradually, the coordinates (X2, Y2) of the center position of face image B on display area 502 are moved gradually toward the coordinates (600, 400) which is the original position of face image B.

The position of display range f3 is changed continuously from the move start position (1600, 750) toward the move end position (1500, 500). The move end position (1500, 500) is the center position of display area 503, i.e., the center position of right partial image of the still image. The size of display range f3 is changed continuously from the initial size explained in FIG. 7 to a size coinciding with the size of display area 503. The effect process module 3021 displays a partial image in display range f3 on display area 503. Accordingly, as the position and size of display range f3 change gradually, the coordinates (X3, Y3) of the center position of face image C on display area 503 are moved gradually toward the coordinates (1600, 750) which is the original position of face image C.

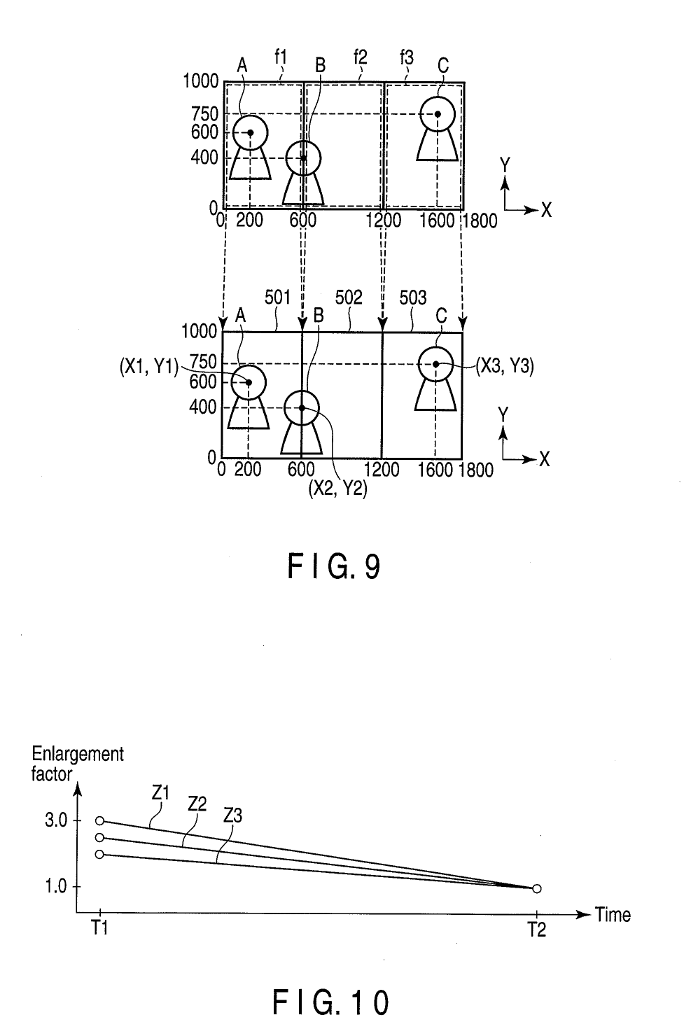

FIG. 9 shows the size and position of each of three display ranges f1, f2, f3 corresponding to the second display mode (the display mode shown in illustration (4) of FIG. 6).

In the second display mode, three display ranges f1, f2, f3 are set to positions corresponding to three display areas 501, 502, 503, respectively. Specifically, the coordinates of the center positions of three display ranges f1, f2, f3 coincide with the coordinates of the center positions of three display areas 501, 502, 503, respectively. In other words, the coordinate of the center position of the display range f1 coincides with center position of the left partial image of the still image, the coordinate of the center position of the display range f2 coincides with center position of the central partial image of the still image, and the coordinate of the center position of the display range f3 coincides with center position of the right partial image of the still image. In addition, the sizes of three display ranges f1, f2, f3 coincide with the sizes of three display areas 501, 502, 503, respectively. Therefore, in the second display mode, the left partial image of the still image is displayed on display area 501. The central partial image of the still image is displayed on display area 502. The right partial image of the still image is displayed on the display area 503. Accordingly, the entire still image is displayed on a display screen composed of display areas 501, 502, 503.

As described above, with the embodiment, even when a plurality of face images appear in, for example, any position of a photograph, the plurality of face images can be displayed in such a manner that they are aligned with one another in a plurality of display areas. Accordingly, even if the faces of a plurality of persons have concentrated in a part of a still image, or even if the faces of a plurality of persons have dispersed to separate areas of a still image, the faces of the plurality of persons can be shown simultaneously to the user in an easy-to-see manner. Therefore, it is possible to show the user in an easy-to-understand manner what persons are comprised in a still image, such as a photograph.

Furthermore, with the embodiment, by changing the position and size of each of a plurality of display ranges corresponding to a plurality of display areas, the display mode of the display screen can be caused to transit from the first display mode in which a plurality of face images are displayed on a plurality of display areas in a one-to-one correspondence to the second display mode in which the whole original photograph is displayed on the display screen. Accordingly, not only the positional relationship between the persons in the original photograph but also the background image in the original photograph can be shown to the user.

Furthermore, with the embodiment, since the position and size of each of a plurality of display ranges are changed continuously, the contents of the display screen can be caused to transit from the first display mode to the second display mode smoothly. Accordingly, it is possible to cause a still image to move as if it were a moving image.

Next, how the size and position of each of a plurality of face images are changed in the “trisection zoom-out” mode will be explained with reference to FIGS. 10 to 12.

FIG. 10 shows a change in the enlargement factor applied to each of three face images A, B, C. As described above, in the first display mode, the size of each of three face images A, B, C is normalized by enlargement or reduction to a size fitting the size of a display area. Accordingly, the enlargement factor applied to each of the face images is set to a value differing according to the size of the face image. The effect process module 3021 enlarges a partial image so that the size of a partial image comprised in each display range may fit the size of a corresponding display area. Consequently, the smaller the size of the display range, the larger the enlargement factor applied to the partial image in the display range.

Suppose the enlargement factors applied to face images A, B, C are Z1, Z2, Z3, respectively. At time T1, or in the first display mode, face images A, B, C are enlarged with the enlargement factors Z1, Z2, Z3, respectively. The enlarged images are displayed in display areas 501, 502, and 503, respectively. It takes a specific length of time (=T2−T1) to transit from the first display mode to the second display mode. In the transition from the first display mode to the second display mode, the value of each of enlargement factors Z1, Z2, Z3 is changed continuously so that the value may be decreased to “1” (with no zoom).

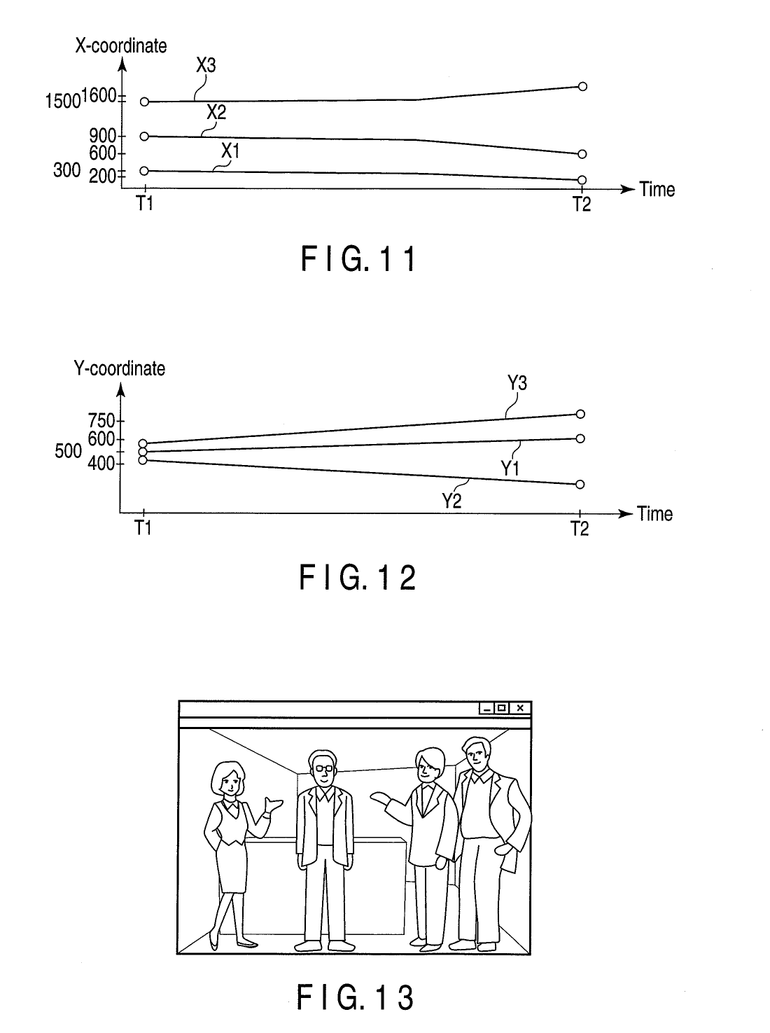

FIG. 11 shows a change in the X-coordinate of the center position of each of face images A, B, C on the display screen. FIG. 12 shows a change in the Y-coordinate of the center position of each of face images A, B, C on the display screen.

At time T1, that is, in the first display mode, the coordinates (X1, Y1) of the center position of face image A on the display screen are set to the coordinates (300, 500) of the center position of display area 501. The coordinates (X2, Y2) of the center position of face image B on the display screen are set to the coordinates (900, 500) of the center position of display area 502. The coordinates (X3, Y3) of the center position of face image C on the display screen are set to the coordinates (1500, 500) of the center position of display area 503.

In the transition from the first display mode to the second display mode, as the position and size of each of display ranges f1, f2, f3 are changed, the coordinates (X1, Y1) of the center position of face image A are moved from the coordinates (300, 500) toward the coordinates (200, 600) corresponding to the position of face image A on the still image. Similarly, the coordinates (X2, Y2) of the center position of face image B are moved from the coordinates (900, 500) toward the coordinates (600, 400) corresponding to the position of face image B on the still image. The coordinates (X3, Y3) of the center position of face image C are moved from the coordinates (1500, 500) toward the coordinates (1600, 750) corresponding to the position of face image C on the still image.

The position in the X-direction of each face image is not necessarily changed linearly. As shown in FIG. 11, the position may be changed slowly in the first half of the transition from the first display mode to the second display mode (the period from T1 to T2) and at a relatively higher speed in the second half. Control of the position in the X-direction can be realized by controlling, for example, the speed at which the position of each display range is moved in the X-direction. This enables face images A, B, C to stay in display areas 501, 502, 503 as long as possible.

While in the embodiment, the display screen has been divided into three display areas, the number of display areas may be an arbitrary number not less than two. When the number of face images comprised in a still image to be reproduced is larger than the number of display areas, as many face images as correspond to the display areas may be selected from the face images comprised in the still image and the selected face images may be displayed in the display areas, respectively. For example, face images larger in size may be selected preferentially. Alternatively, face images belonging to a group previously specified by the user may be selected preferentially.

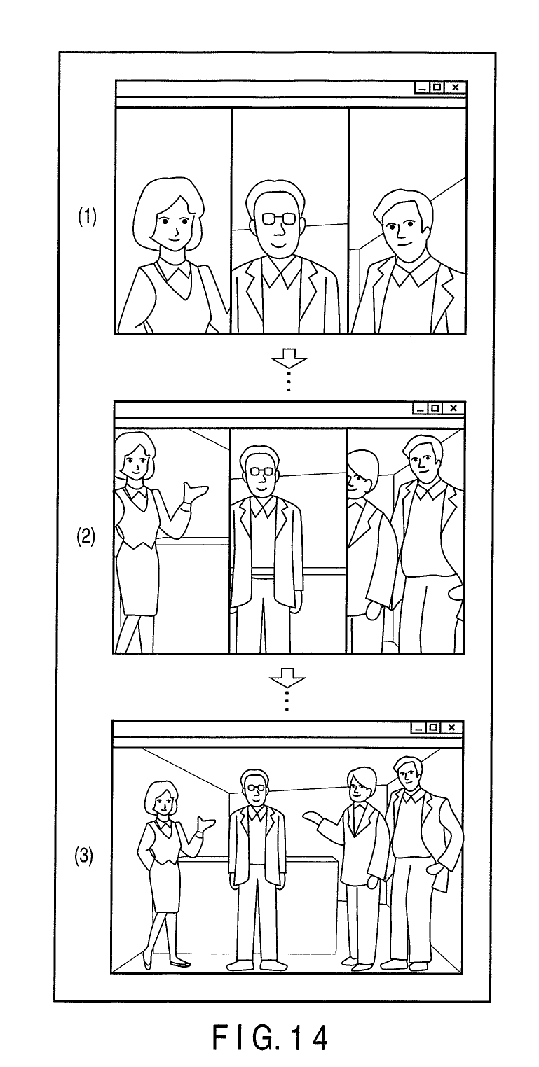

Next, another example of the “trisection zoom-out” mode will be explained with reference to FIGS. 13 and 14. FIG. 13 shows an example of the selected still image. The still image is a digital photograph that comprises the face images of four persons. FIG. 14 shows the transition of images on the display screen when the still image of FIG. 13 is reproduced in the “trisection zoom-out” mode.

Illustration (1) of FIG. 14 shows three images displayed in three display areas on the display screen. In the first display mode, three of the four face images comprised in the still image of FIG. 14 are selected. The position and size of each of three display ranges corresponding to three display areas are set so that the display range may comprise at least a corresponding face image. Three partial images comprised in three display ranges, respectively, are displayed in three display areas, respectively, as shown in illustration (1) of FIG. 14. In this case, the size of each of three partial images (three face images) is enlarged so as to be normalized to a size fitting the size of each of the display areas.

Illustration (2) of FIG. 14 shows one of a plurality of images displayed on the display screen in the transition from the first display mode (the displayed state shown in illustration (1) of FIG. 14) to the second display mode (the displayed state shown in illustration (3) of FIG. 14). During the transition, the size of the display range corresponding to each of the three display areas is increased gradually and the center position of the display range corresponding to each of the three display areas is moved gradually toward the center position of the corresponding one of the three areas on the still image. As a result, the displayed image in each of the display areas is zoomed out gradually. In addition, the displayed image in each of the display areas is panned toward the original area on the still image corresponding to the display area. In the right display area, an image of a person not displayed in the first display mode appears gradually.

Illustration (3) of FIG. 14 shows an image displayed on a display screen composed of three display areas in the second display mode. In the second display mode, the entire still image is displayed on the display screen. Specifically, of the three partial images obtained by dividing the still image longitudinally into three parts, the left partial image is displayed in the left display area. The central one of the three partial images is displayed in the central display area. The right one of the three partial images is displayed in the right display area.

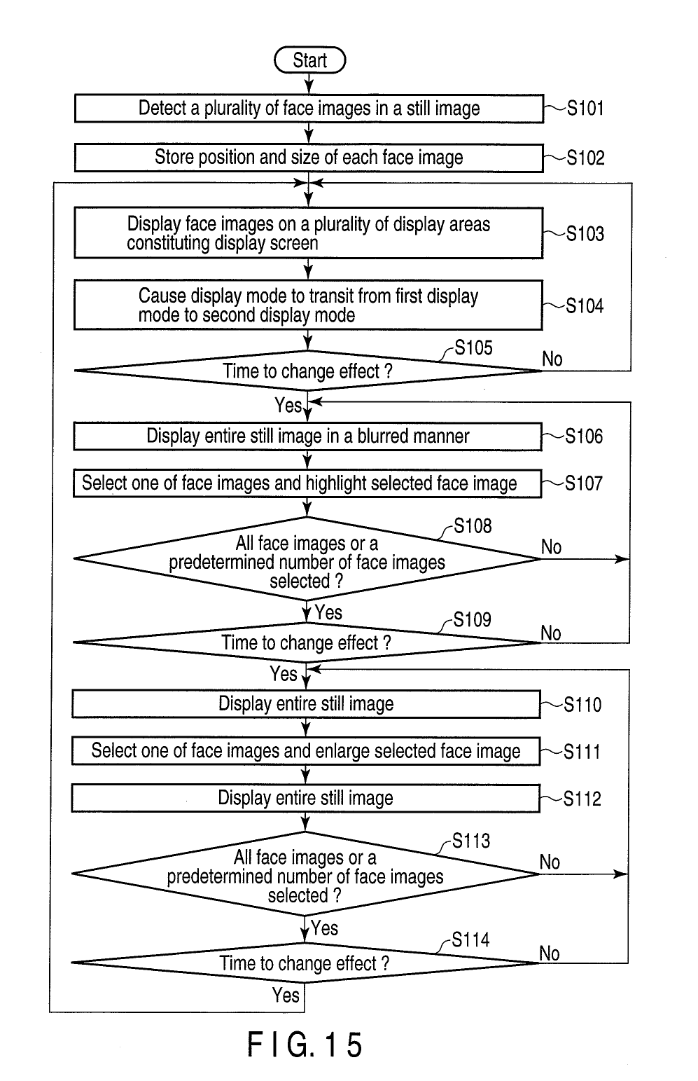

FIG. 15 is a flowchart to explain an example of the procedure for a first effect process using effects comprised in effect mode A.

First, the content reproduction application program 202 detects a plurality of face images comprised in a still image (block S101). Next, the content reproduction application program 202 stores the position and size of each of the face images detected (block S102).

The content reproduction application program 202 performs effect in the “trisection zoom-out” mode. In this case, the content reproduction application program 202 displays the detected face images on a plurality of display areas constituting the display screen (block S103). Then, the content reproduction application program 202 causes the display mode to transit from the first display mode to the second display mode (block S104).

Then, the content reproduction application program 202 determines whether it is time to change the effect (block S105). If it is not time to change the effect (NO in block S105), the content reproduction application program 202 returns control to block S103 and performs effect again in the “trisection zoom-out” mode.

If it is time to change the effect (YES in block S105), the content reproduction application program 202 displays the entire still image in a blurred manner (block S106). Then, the content reproduction application program 202 selects one of the detected face images in the still image and highlights the selected face image (block S107).

Next, the content reproduction application program 202 determines whether all of the face images or a predetermined number of face images have been selected (block S108). If all of the face images or a predetermined number of face images have been selected (YES in block S108), the content reproduction application program 202 determines whether it is time to change the effect (block S109). If all of the face images or a predetermined number of face images have not been selected (NO in block S108), or if it is not time to change the effect (NO in block S109), the content reproduction application program 202 returns control to block S106.

If it is time to change the effect (YES in block S109), the content reproduction application program 202 displays the entire still image (block S110). Then, the content reproduction application program 202 selects one of the face images, enlarges the selected face image, and displays the enlarged image (block S111). Then, the content reproduction application program 202 displays the entire still image (block S112).

The content reproduction application program 202 determines whether all of the face images or a predetermined number of face images have been selected (block S113). If all of the face images or a predetermined number of face images have been selected (YES in block S113), the content reproduction application program 202 determines whether it is time to change the effect (block S114). If all of the face images or a predetermined number of face images have not been selected (NO in block S113), or if it is not time to change the effect (NO in block S114), the content reproduction application program 202 returns control to block S110.

If it is time to change the effect (YES in block S114), the content reproduction application program 202 returns control to block S102.

By the above processes, the content reproduction application program 202 can display on the screen the still image subjected to the effects comprised in effect mode A.

Next, a “one-by-one spotlight” mode, one effect comprised in effect mode A, will be explained. The “one-by-one spotlight” mode is a mode in which the entire still image is displayed blurredly on the screen and a plurality of face images comprised in the still image are highlighted one by one.

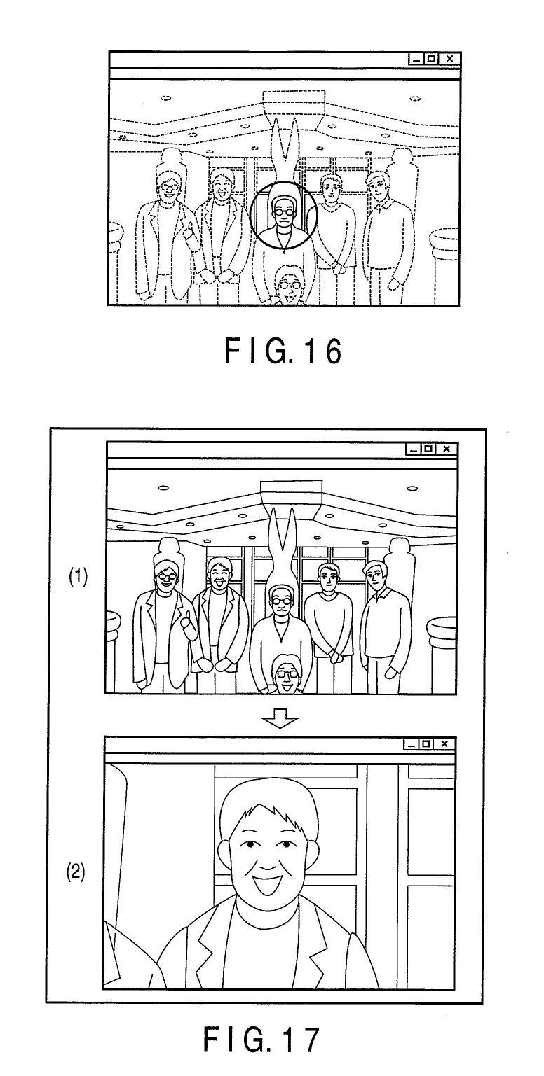

An example of the “one-by-one spotlight” mode will be explained with reference to FIG. 16. The still image displayed on the screen of FIG. 16 is a digital photograph comprising the face images of six persons. In FIG. 16, the face image of person near the center of the still image is highlighted. A face image to be highlighted is changed among the face images of six persons.

A “one-by-one zoom-in/-out” mode, one effect comprised in effect mode A, will be explained. The “one-by-one zoom-in/-out” mode is a mode in which the entire still image is displayed on the screen and a plurality of face images comprised in the still image are enlarged (zoomed in) one by one.

An example of the “one-by-one zoom-in/-out” mode will be explained with reference to FIG. 17. The still image displayed on the screen of FIG. 17 is a digital photograph comprising the face images of six persons. In the still image, the face image of the second person from the left is enlarged.

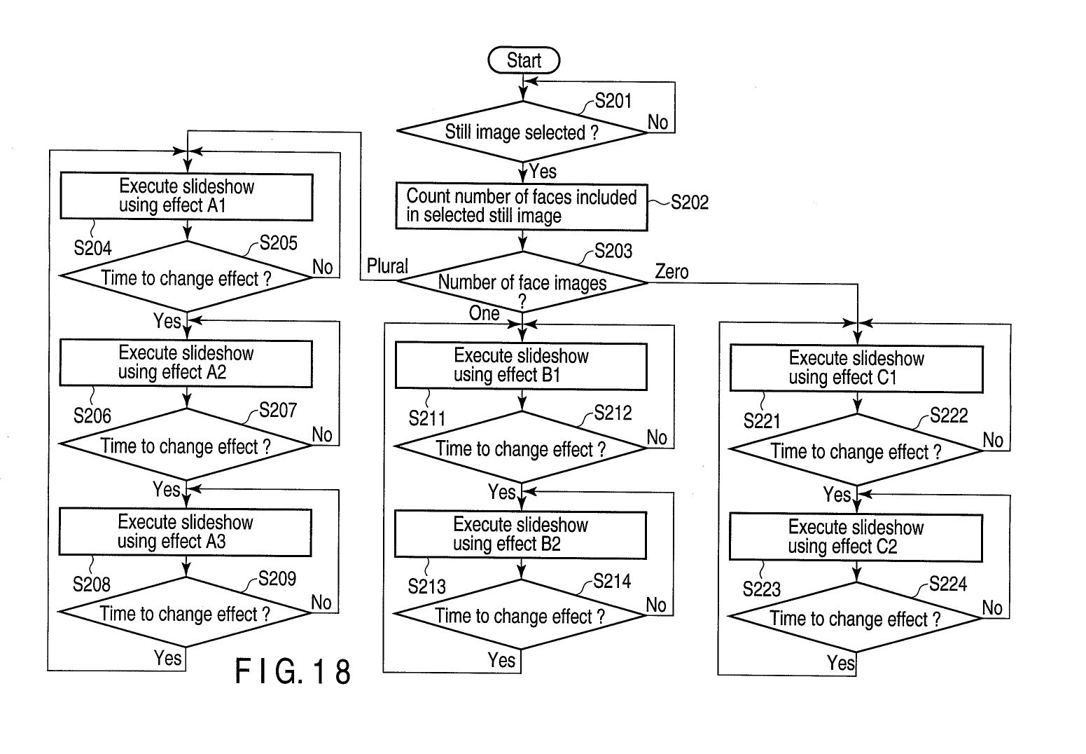

Next, the procedure for an effect change process according to the number of face images will be explained with reference to a flowchart in FIG. 18.

The effect mode A comprises effects A1, A2 and A3 which are suitable for a still image comprising a plurality of face images, the effect mode B comprises effects B1 and B2 which are suitable for a still image comprising one face image, the effect mode C comprises effects C1 and C2 which are suitable for a still image comprising no face image.

First, the content reproduction application program 202 determines whether a still image to be reproduced has been selected (block S201). If a still image has not been selected (NO in block S201), the content reproduction application program 202 executes block S201 again.

If a still image to be reproduced has been selected (YES in block S201), the content reproduction application program 202 counts the number of face images comprised in the selected still image (block S202). Then, the content reproduction application program 202 switches between processes according to the number of face images counted (block S203).

If a plurality of face images are comprised in the selected still image (plural in block S203), the content reproduction application program 202 executes a slideshow using effect A1 (block S204). Then, the content reproduction application program 202 determines whether it is time to change the effect (block S205). If it is not time to change the effect (NO in block S205), the content reproduction application program 202 returns control to block S204.

If it is time to change the effect (YES in block 205), the content reproduction application program 202 executes a slideshow using effect A2 (block S206). Then, the content reproduction application program 202 determines whether it is time to change the effect (block S207). If it is not time to change the effect (NO in block S207), the content reproduction application program 202 returns control to block S206.

If it is time to change the effect (YES in block 207), the content reproduction application program 202 executes a slideshow using effect A3 (block S208). Then, the content reproduction application program 202 determines whether it is time to change the effect (block S209). If it is not time to change the effect (NO in block S209), the content reproduction application program 202 returns control to block S208.

If it is time to change the effect (YES in block 209), the content reproduction application program 202 returns control to block S204.

If only one face image is comprised in the selected still image (one in block S203), the content reproduction application program 202 executes a slideshow using effect B1 (block S211). Then, the content reproduction application program 202 determines whether it is time to change the effect (block S212). If it is not time to change the effect (NO in block S212), the content reproduction application program 202 returns control to block S211.

If it is time to change the effect (YES in block S212), the content reproduction application program 202 executes a slideshow using effect B2 (block S213). Then, the content reproduction application program 202 determines whether it is time to change the effect (block S214). If it is not time to change the effect (NO in block S214), the content reproduction application program 202 returns control to block S213. If it is time to change the effect (YES in block 214), the content reproduction application program 202 returns control to block S211.

If the number of face images comprised in the selected still image is zero (zero in block S203), the content reproduction application program 202 executes a slideshow using effect C1 (block S221). Then, the content reproduction application program 202 determines whether it is time to change the effect (block S222). If it is not time to change the effect (NO in block S222), the content reproduction application program 202 returns control to block S221.

If it is time to change the effect (YES in block S222), the content reproduction application program 202 executes a slideshow using effect C2 (block S223). Then, the content reproduction application program 202 determines whether it is time to change the effect (block S224). If it is not time to change the effect (NO in block S224), the content reproduction application program 202 returns control to block S223. If it is time to change the effect (YES in block 224), the content reproduction application program 202 returns control to block S221.

By the above processes, the content reproduction application program 202 can display a still image subjected to a different effect process according to the number of face images comprised in the still image to be processed.

One or more effects to be used are selected at random from a plurality of effects previously prepared in each effect mode. The effects in effect mode C suitable for a case where no face image is comprised can be applied to a case where face images are comprised. The effects in effect mode B suitable for a case where only one face image is comprised can be applied to a case where a plurality of face images are comprised in a still image to be reproduced, provided that one of the face images is selected. For example, the effect is applied to a case where attention is focused on only a target person.

Next, a “one-face effect” mode, one effect comprised in effect mode B, will be explained. The “one-face effect” mode is a mode in which the entire still image is displayed on the screen, one of the face images comprised in the still image is subjected to an effect, and the resulting image is displayed.

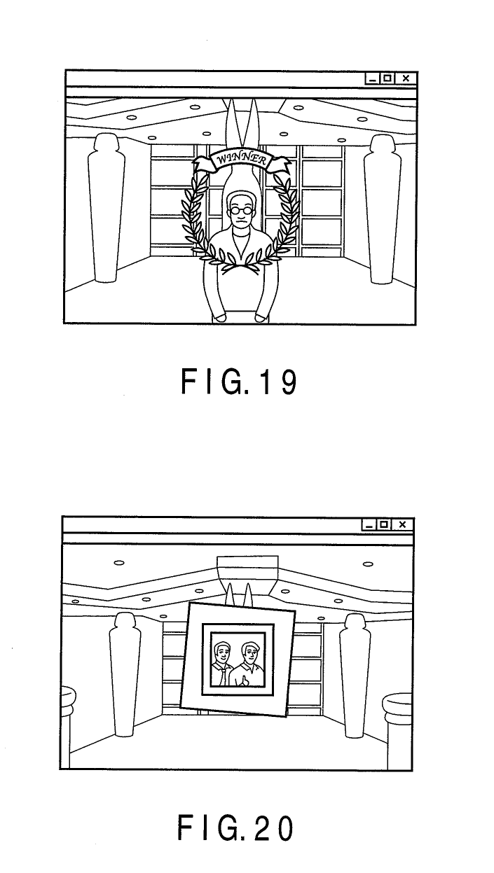

An example of the “one-face effect” mode will be explained with reference to FIG. 19. A still image displayed on the screen of FIG. 19 is a digital photograph comprising the face image of a person. In the still image, an image of laurels is superimposed on the face image of a person near the center of the image.

In addition, a “no-face effect” mode, one effect comprised in effect mode C, will be explained. The “no-face effect” mode is a mode in which the entire still image is displayed on the screen, the still image is subjected to an effect, and the resulting image is displayed.

An example of the “no-face effect” mode will be explained with reference to FIG. 20. A still image displayed on the screen of FIG. 20 is a digital photograph with no face. In the still image, for example, a diamond-shaped image (object) is superimposed on the central part of the still image. The object may be moved over the still image.

As described above, with the embodiment, the size and position of each of a plurality of face images are detected from a still image. On the basis of the detection result, a short movie with the effect of focusing on a plurality of face images can be displayed. Particularly in the “trisection zoom-out” mode, the position and size of a display range on the still image are controlled separately on a display area basis. Then, at first, a plurality of partial images comprising a plurality of face images are displayed automatically in such a manner that they are dispersed to a plurality of display areas. Then, for example, as time passes, the partial images displayed in the individual display areas change gradually. Finally, the entire still image is displayed on the display screen. Accordingly, what kind of person is comprised in a still image, such as a photograph, can be shown to the user in an easy-to-understand manner. In addition, the positional relation between the persons appearing in the original photograph can also be shown to the user.

Since the short movie function of the embodiment has been realized by a computer program, the same effect as that of the embodiment can be obtained easily by just installing the computer program from a computer-readable storage medium that has stored the computer program into an ordinary computer.

The various modules of the systems described herein can be implemented as software applications, hardware and/or software modules, or components on one or more computers, such as servers. While the various modules are illustrated separately, they may share some or all of the same underlying logic or code.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a face image detection module configured to detect face images in a still image;
a display range setting module configured to set positions and sizes of display ranges on the still image such that the display ranges comprise the face images respectively, the display ranges being associated with display areas obtained by dividing a display screen; and
a display control module configured to display partial images comprised in the display ranges on the display areas in order to display the face images on the display areas respectively, and to change the position and size of each of the display ranges such that contents displayed on the display screen gradually and continuously change and a display mode of the display screen is caused to transit from a first display mode in which the face images are displayed on the display areas respectively to a second display mode in which an entire image of the still image is displayed on the display screen,
wherein each module is at least partially implemented by hardware.

2. The electronic apparatus of claim 1, wherein the display control module is configured to enlarge each of the partial images such that a size of each of the partial images fits a size of a corresponding display area.

3. The electronic apparatus of claim 1, wherein the display control module is configured to select as many face images as the display areas from the face images comprised in the still image if the number of face images comprised in the still image is larger than the number of the display areas.

4. The electronic apparatus of claim 1, wherein the display control module is configured to switch an effect to which a still image to be reproduced is subjected between a first effect mode in which the display mode of the display screen is caused to transit from the first display mode to the second display mode and a second effect mode differing from the first effect mode.

5. The electronic apparatus of claim 1, wherein the display control module is configured to switch an effect to which a still image to be reproduced is subjected between a first effect mode in which the display mode of the display screen is caused to transit from the first display mode to the second display mode and a second effect mode differing from the first effect mode, based on the number of face images comprised in the still image to be reproduced.

6. An image display method comprising:
detecting a plurality of face images in a still image;
setting positions and sizes of display ranges on the still image such that the display ranges comprise the face images respectively, the display ranges being associated with display areas obtained by dividing a display screen;
displaying partial images comprised in the display ranges on the display areas in order to display the face images on the display areas respectively; and
changing the position and size of each of the display ranges such that contents displayed on the display screen gradually and continuously change and a display mode of the display screen is caused to transit from a first display mode in which the face images are displayed on the display areas respectively to a second display mode in which an entire image of the still image is displayed on the display screen.

7. The image display method of claim 6, wherein the displaying comprises enlarging each of the partial images such that a size of each of the partial images fits a size of a corresponding display area.

8. The image display method of claim 6, wherein the displaying comprises selecting as many face images as the display areas from the face images comprised in the still image if the number of face images comprised in the still image is larger than the number of the display areas.

9. A computer readable non-transitory storage medium comprising a computer program which is executable by a computer, wherein the program causes the computer to execute a method comprising:
detecting a plurality of face images in a still image;
setting positions and sizes of display ranges on the still image such that the display ranges comprise the face images respectively, the display ranges being associated with display areas obtained by dividing a display screen;
displaying partial images comprised in the display ranges on the display areas in order to display the face images on the display areas respectively; and
changing the position and size of each of the display ranges such that contents displayed on the display screen gradually and continuously change and a display mode of the display screen is caused to transit from a first display mode in which the face images are displayed on the display areas respectively to a second display mode in which an entire image of the still image is displayed on the display screen.

10. The electronic apparatus of claim 1, wherein the display control module is configured to display the partial images on the display areas, respectively such that center positions of the partial images are located in center positions of the display areas, respectively.

11. The image display method of claim 6, wherein the displaying comprises displaying the partial images on the display areas, respectively such that center positions of the partial images are located in center positions of the display areas, respectively.

12. The non-transitory storage medium of claim 9, wherein the displaying comprises displaying the partial images on the display areas, respectively such that center positions of the partial images are located in center positions of the display areas, respectively.

13. An electronic apparatus comprising:
a face image detection module configured to detect face images in a still image;
a display range setting module configured to set positions and sizes of display ranges on the still image such that the display ranges comprise the face images respectively, the display ranges being associated with display areas obtained by dividing a display screen; and
a display control module configured to change the position and size of each of the display ranges such that contents displayed on the display screen gradually and continuously change and a display mode of the display screen is caused to transit from a first display mode in which the face images are displayed on the display areas respectively to a second display mode in which an entire image of the still image is displayed on the display screen,
wherein each module is at least partially implemented by hardware.

14. The electronic apparatus of claim 13, wherein the display control module is configured to display partial images included in the display ranges on the display areas, respectively such that center positions of the partial images are located in center positions of the display areas, respectively.

15. The electronic apparatus of claim 13, wherein the display control module is configured to enlarge a partial image included in each of the display ranges such that a size of the partial image fits a size of a corresponding display area.

16. The electronic apparatus of claim 13, wherein the display control module is configured to select as many face images as the display areas from the face images included in the still image if the number of face images included in the still image is larger than the number of the display areas.

17. The electronic apparatus of claim 13, wherein the display control module is configured to switch an effect to which a still image comprising a plurality of face images is subjected between a first effect mode in which the display mode of the display screen is caused to transit from the first display mode to the second display mode and a second effect mode differing from the first effect mode.

18. The electronic apparatus of claim 13, wherein the display control module is configured to switch an effect to which a still image to be reproduced is subjected between a first effect mode in which the display mode of the display screen is caused to transit from the first display mode to the second display mode and a second effect mode differing from the first effect mode, based on the number of face images included in the still image to be reproduced.
